(19) United States
(12) Patent Application Publication
(10) Pub. No.: US 2020/0409693 A1
(43) Pub. Date: Dec. 31, 2020

(54) FILE GENERATION METHOD, DEVICE AND APPARATUS, AND STORAGE MEDIUM

(71) Applicant: Baidu Online Network Technology (Beijing) Co., Ltd., Beijing (CN)

(72) Inventors: Kaisheng Song, Beijing (CN); Xuening Deng, Beijing (CN); Yaowen Qi, Beijing (CN); Huan Tang, Beijing (CN); Liangcheng Wu, Beijing (CN); Jiale Wang, Beijing (CN); Lei Zhong, Beijing (CN); Peng Yuan, Beijing (CN); Linlin Zhao, Beijing (CN); Sen Li, Beijing (CN)

(21) Appl. No.: 16/696,097

(22) Filed: Nov. 26, 2019

(30) Foreign Application Priority Data
Jun. 28, 2019 (CN) 201910583571.5

(51) Int. Cl. G06F 8/77; G06F 8/33

(52) U.S. Cl. CPC G06F 8/77; G06F 8/34; G06F 8/33

(57) ABSTRACT

A file generation method, device and apparatus, as well as a storage medium are provided. The method includes: receiving attribute information of a feature; editing a business logic of the feature; and generating a description file for the feature according to the attribute information and the business logic. In the embodiments of the present disclosure, the description file for the feature can be generated using the attribute information and the business logic of the feature. The description file can be directly converted into feature service codes, thus contributing to a rapid service generation and reducing the programming difficulty of the service development.

### CROSS-REFERENCE TO RELATED APPLICATION

This application claims priority to Chinese Patent Application No. 201910583571.5, entitled “File Generation Method, Device and Apparatus, and Storage Medium”, and filed on Jun. 28, 2019, which is hereby incorporated by reference in its entirety.

### TECHNICAL FIELD

The present disclosure relates to a technical field of computers, and particularly to a file generation method, device and apparatus, and a storage medium.

### BACKGROUND

In the development process of plot applications such as games, it is necessary to draw up a game plan, select a development language and a programming tool, establish a development environment and an underlying framework, determine an artistic style and a production standard, and build a client/server for the development, etc. Then, developers write the codes according to the game plan.

The game plan may include many plots, so the development process is complicated and the programming is very professional, which often requires team cooperation, centralized assignment of personnel, and determination of a development cycle, etc.

### SUMMARY

A file generation method, device and apparatus, and a storage medium are provided according to embodiments of the present disclosure, so as to solve one or more technical problems in the existing technologies.

In a first aspect, a file generation method is provided according to an embodiment of the present disclosure, comprising:

receiving attribute information of a feature;

editing a business logic of the feature; and

generating a description file for the feature according to the attribute information and the business logic.

In one embodiment, receiving attribute information of a feature comprises:

receiving the attribute information from a development end, wherein the attribute information comprises at least one of a type, basic information, and activation intention of the feature;

wherein the basic information of the feature comprises at least one of a name, an icon, ownership information, and a presentation image of the feature.

In one embodiment, editing a business logic of the feature comprises:

determining a plurality of components in a description file structure, according to scenes in the business logic of the feature;

determining a relationship of the plurality of components according to a relationship of the plurality of scenes; and

editing, on an edition interface, an attribute of the each component and the relationship of the plurality of components.

In one embodiment, the description file structure comprises one or more of a session component, a node component, a card component, a presentation component, a template component, a hint component, a speech component, a condition-related state component, and a user-related state component.

In one embodiment, a type of the node component comprises one or more of a welcome node, an end node, a quit node, an interaction node, and an automatic jump node.

In one embodiment, the generating a description file for the feature according to the attribute information and the business logic comprises:

generating a description file in a JSON format or an XML format according to the attribute information, components in the business logic, a relationship of the components, and an attribute of each component.

In a second aspect, a file generation device is provided according to an embodiment of the present disclosure, comprising:

a receiving module configured to receive attribute information of a feature;

an editing module configured to edit a business logic of the feature; and

a generating module configured to generate a description file for the feature according to the attribute information and the business logic.

In one embodiment, the receiving module is further configured to receive the attribute information from a development end, wherein the attribute information comprises at least one of a type, basic information, and activation intention of the feature;

wherein the basic information of the feature comprises at least one of a name, an icon, ownership information, and a presentation image of the feature.

In one embodiment, the editing module comprises:

a first determining sub-module configured to determine a plurality of components in a description file structure, according to scenes in the business logic of the skill;

a second determining sub-module configured to determine a relationship of the plurality of components according to a relationship of the plurality of scenes; and

an editing sub-module configured to edit, on an edition interface, an attribute of the each component and the relationship of the plurality of components.

In one embodiment, the description file structure comprises one or more of a session component, a node component, a card component, a presentation component, a template component, a hint component, a speech component, a condition-related state component, and a user-related state component.

In one embodiment, a type of the node component comprises one or more of a welcome node, an end node, a quit node, an interaction node, and an automatic jump node.

In one embodiment, the generating module is further configured to generate a description file in a JSON format or an XML format according to the attribute information, components in the business logic, a relationship of the components, and an attribute of each component.

In a third aspect, a file generation apparatus is provided according to an embodiment of the present disclosure, and the functions thereof can be realized by hardware or by executing corresponding software through the hardware. The hardware or the software comprises one or more modules corresponding to the above functions.

In a possible implementation, the structure of the device comprises a memory configured to store a program supporting the device to perform the file generation method, and a processor configured to execute the program stored in the memory. The device may further comprise a communication interface configured to be communicated with other device or a communication network.

In a fourth aspect, a computer readable storage medium is provided according to an embodiment of the present disclosure, configured to store computer software instructions used by a file generation apparatus, and comprising a program involved in performing the file generation method.

One of the above technical solutions has the following advantages or beneficial effects. The description file of a feature can be generated using attribute information and the business logic of the feature. The description file can be directly converted into feature service codes, thus facilitating to a rapidly generate a service and reducing the programming difficulty of the service development.

The above summary is for the purpose of description, and is not intended to be limiting in any way. In addition to the illustrative aspects, embodiments and features described above, further aspects, embodiments and features of the present disclosure will be readily apparent with reference to the drawings and the following detailed descriptions.

### BRIEF DESCRIPTION OF THE DRAWINGS

In the drawings, unless otherwise designated, the same reference numeral refers to the same or similar parts or elements throughout the drawings. These drawings are not necessarily drawn to scale. It should be understood that these drawings depict only some embodiments disclosed in accordance with the present disclosure and should not be considered as limitations to the scope of the present disclosure.

FIG. 1 illustrates a flowchart of a file generation method according to an embodiment of the present disclosure.

FIG. 2 illustrates a flowchart of a file generation method according to an embodiment of the present disclosure.

FIG. 3 illustrates a flowchart of description file coding according to an embodiment of the present disclosure.

FIG. 4 illustrates a structural block diagram of a file generation device according to an embodiment of the present disclosure.

FIG. 5 illustrates a structural block diagram of a file generation device according to an embodiment of the present disclosure.

FIG. 6 illustrates a structural diagram of an example of a system for generating a service according to an embodiment of the present disclosure.

FIG. 7 illustrates a flowchart of an example of a method for generating a service according to an embodiment of the present disclosure.

FIG. 8a illustrates a schematic diagram of a template selection interface of a visualized editor.

FIGS. 8b and 8c illustrate schematic diagrams of a code edition interface of a visualized editor.

FIG. 9 illustrates a structural block diagram of a file generation apparatus according to an embodiment of the present disclosure.

### DETAILED DESCRIPTION

In the following, certain embodiments are briefly described. As will be recognized by persons skilled in the art, the described embodiments can be modified in a variety of different ways without departing from the spirit or scope of the present disclosure. Accordingly, the drawings and descriptions are regarded as illustrative in nature rather than restrictive.

FIG. 1 illustrates a flowchart of a file generation method according to an embodiment of the present disclosure. As illustrated in FIG. 1, the method may comprise S11 to S13.

In S11: attribute information of a feature is received.

The feature may comprise an application of an Internet service on an artificial intelligent interactive device. Taking a dialogical artificial intelligent device as an example, a user gives a question of ‘what's the weather like today’ to the device, and the device answers ‘it's cloudy today and the temperature is xxx, . . . ’. The question of the user can be understood by a weather service at a background of the device and an answer may be provided. In this case, the weather service is a feature.

In one embodiment, the feature is a plot-type feature, and the description file is a plot description file. Some skills such as a game, a story, and the like include a plot related to multiple scenes. A description file of a feature with a plot may be read from a file storage end.

In one embodiment, in S11, the attribute information is received from a development end. Herein, the attribute information comprises at least one of a type, basic information, and an activation of the skill. The basic information of the feature comprises at least one of a name, an icon, ownership information, marketing terms, a displaying image, and charging information of the skill. The ownership information may comprise an author, a manufacturer, etc. The activation intention of the feature may comprise a purpose of activating the feature, such as ‘start Game A’, ‘enter Game A’, etc.

An open platform of the dialogical artificial intelligent system on the development end, such as a DuerOS BOT Platform (DBP), the attribute information of a feature is generated when creating the skill. DuerOS is a dialogical artificial intelligent operation system, DBP is an open platform of duerOS, and BOT may be a chat robot dialog system.

In S12, a business logic of the feature is edited.

The business logic of the feature may comprise various plots required to implement the skill. For example, how to enter a game, a sequence of presenting scenes after entering a game, how to enter a next scene, etc. The scenes may comprise guidance information, a background, music, a dialog, etc.

In S13, a description file is generated for the feature according to the attribute information and the business logic.

For example, in an interface of a visualized editor, after edition is completed according to the attribute information and the business logic of the feature, a description file in a description file structure may be automatically generated in response to an operation of clicking a code export control by a developer.

In embodiments of the present disclosure, the description file of the feature can be generated using the attribute information and the business logic of the feature. The description file can be directly converted into feature service codes, thus facilitating to rapidly generate a service and reducing the programming difficulty of the service development.

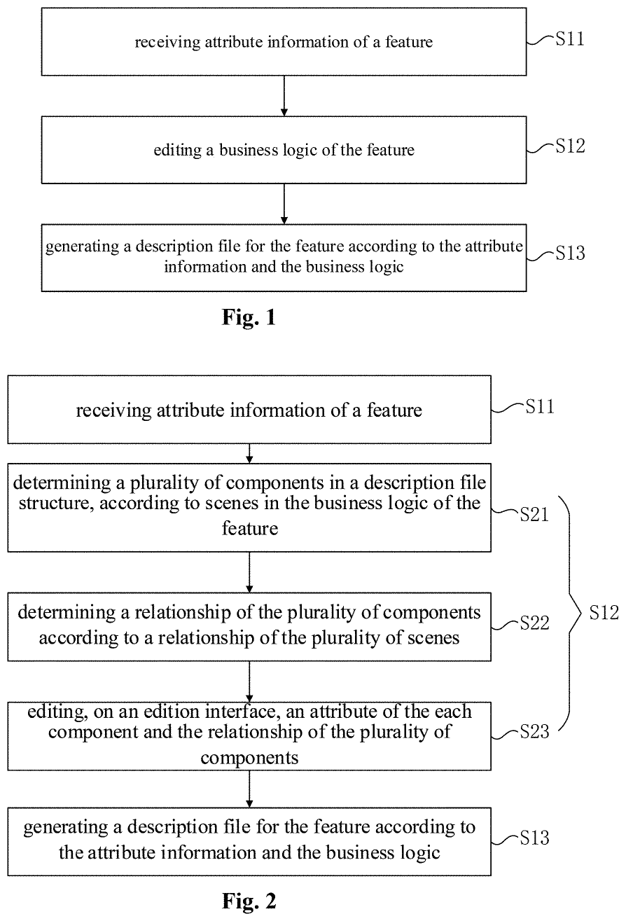

In one embodiment, as illustrated in FIG. 2, S12 comprises S21 to S23.

In S21, a plurality of components in a description file structure are determined according to scenes in the business logic of the skill.

In S22, a relationship of the plurality of components is determined according to a relationship of the plurality of scenes.

In S23, on an edition interface, an attribute of the each component and the relationship of the plurality of components are edited.

In one example, the business logic of the feature may be edited using a visualized editor. The visualized editor may comprise an edition interface and a selection interface.

The edition interface may be in a page presentation state or a file edition state. In the page presentation state of the edition interface, a structure presentation area and an edition area are displayed in the edition interface. The structure presentation area comprises the framework structures and the hierarchies of the plurality of components described with an interface presentation language, and the edition area comprises an editable attribute of each component. After a component to be used (hereinafter referred to as a target component) is determined according to the business logic of the feature, the target component may be selected from the framework structures and the hierarchies displayed in the structure presentation area, in response to a component selection operation. After the target component is selected, logical description codes of the attribute of the target component may be edited in the edition area in response to an edition operation on the target component. In the file edition state of the edition interface, the logical description codes of the currently edited component are displayed on the edition interface.

In addition, a device selection control and a simulated image presentation area are also displayed on the edition interface. Information on a selected device is determined in response to a selection operation on the device selection control. In the simulated image presentation area, a simulated presentation result representing a fit relationship between the currently edited logical description codes and the information of the selected device is presented. For example, in the edition interface of the visualized editor, it is possible to select a screen type of a presentation device for the feature, and edit the components in the description file structure for the scenes comprised in the business logic and the relationship among the components, etc. The description of each component comprises an attribute of the component, and the logical description codes of each component may be converted into execution codes accordingly. Then, in response to a simulation operation, a simulated presentation result represent a fit relationship between the feature and the screen type is displayed in the simulated image presentation area.

Selectable layout templates, creation controls, uploading file options and the like may be displayed in the template selection interface. For example, a desired template may be selected in the template selection interface of the visualized editor.

A code export control is displayed in the edition interface. In response to an operation on the code export control, the currently edited logical description codes are exported into a file in a format defined by the interface presentation language, such as a JavaScript Object Notification (JSON) format, and the exported file is stored to a designated storage location. For example, in the edition interface of the visualized editor, after the edition is completed according to the attribute information and the business logic of the feature, a description file in the description file structure may be automatically generated in response to an operation of clicking the code export control by the developer.

In one embodiment, the component in the description file structure comprises one or more of a session component, a node component, a card component, a presentation component, a template component, a hint component, a speech component, a condition-related state component, and a user-related state component.

For example, an attribute of the session component may comprise: a game name, a game type, nodes involved, a background image, a session identification, etc. For another example, an attribute of the node component may comprise: a node identification, a node name, a node type, a scene for the node, etc. An attribute of the presentation component may comprise: a template, DuerOS Presentation Language (DPL) description, etc. Specific contents of these attributes may be set in the interface of the visualized editor.

In one embodiment, a type of the node component comprises one or more of a welcome node, an end node, a quit node, an interaction node, and an automatic jumping node.

The description file structure is similar to a Directed Acyclic Graph (DAG), which may divided into a binary tree or any other tree structure from a root node and proceed along different branches according to conditions. Each node may correspond to a scene. Each scene may comprise a plurality of links or steps. For example, the welcome node may correspond to the root node. The quit node may indicate a situation in which quit is required. The interaction nodes may indicate any scene requiring an interaction. The automatic jump node may indicate a transitional scene.

In one embodiment, in S13, a description file of structured data in a JSON format, an XML format and the like is generated according to the attribute information, the components for the business logic, the relationship among the components, and the attributes of respective components. The description file may comprise a game name, nodes, game scenes, etc.

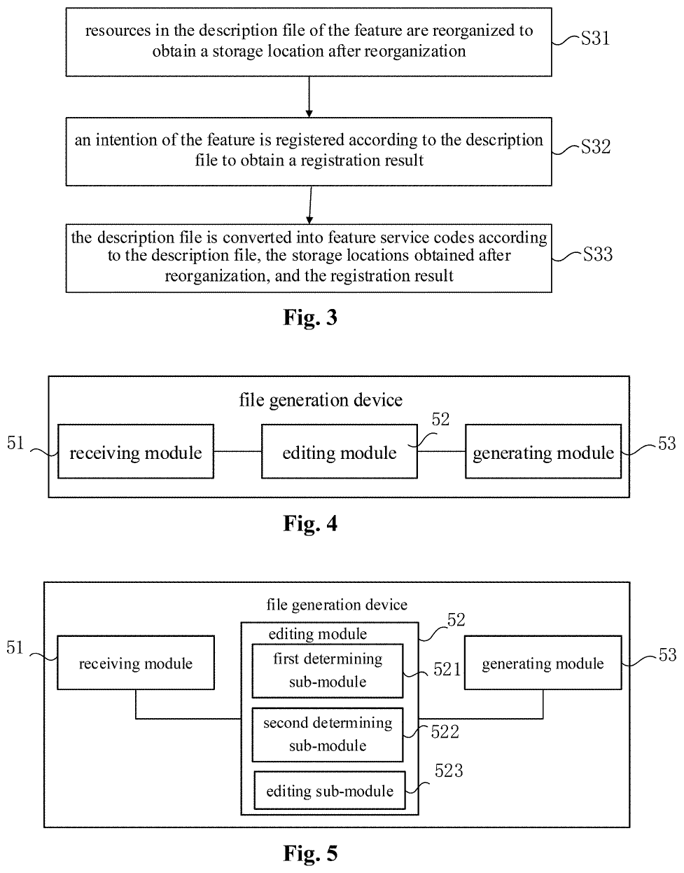

After being generated, the description file may be converted into skill-service codes, and a feature service is deployed using the skill-service codes. As illustrated in FIG. 3, a process of coding a description file may comprise S31 to S33.

In S31, resources in the description file of the feature are reorganized to obtain a storage location after reorganization.

For example, after the resources in the description file are reorganized, they are stored to the storage end, and the storage locations of the resources at the storage end are obtained. A variety of databases are included in the storage end. An image is stored to an image database, a video in the description file is stored to a video database, and an audio in the description file is stored to an audio database. For another example, a webpage address and/or a webpage content in the description file is stored to a webpage database.

The various databases in the example may be located in a same device or different devices. After the resources in a certain description file are reorganized, the storage locations of the resources in the description file are recorded. The storage locations of the required resources are comprised in the generated feature service codes. If certain resources need to be called, it is possible to call these resources through the storage locations thereof in the feature service codes.

In S32, an intention of the feature is registered according to the description file to obtain a registration result.

Various purposes of the feature may be extracted from the description file, such as an activating purpose of the feature, a scene objective for a node, and the like, and these intentions are registered to the development end. At the development end, according to an objective, it is possible to determine a feature service for the intention and a server where the feature service is stored. Moreover, an objective may comprise multiple words, and the words in the objective may be segmented and registered at a dictionary on the development end. In addition, it is also possible to generalize objectives and associate the intention with its similar marketing terms.

In S33, the description file is converted into feature service codes according to the description file, the storage locations obtained after reorganization, and the registration result.

For example, the description file is converted into the feature service codes according to the attribute information and the business logic of the feature comprised in the description file, the storage locations of the resources after reorganization, and the registration result. The code templates of some programming languages such as the Hypertext Preprocessor (PHP) may be preset. During the coding process, the description file is converted into the codes in a certain programming language format using a code generator of the programming language.

In addition, after the coding, the method may further comprise: deploying a feature service using the feature service codes. For example, the service may be deployed in multiple modes as follows.

In Mode 1, the feature service codes are stored to a designated service deployment end.

In Mode 2, the feature service codes and the description file are stored to a designated service deployment end.

The service deployment end may comprise an object storage system such as a Baidu Object Storage (BOS) system, and may also comprise a Content Delivery Network (CDN), etc.

In an application scene, after picking up a user speech to be executed, the user speech may be sent to a speech recognition module. The speech recognition module may perform Automatic Speech Recognition (ASR) on the user speech to obtain a text, and perform Natural Language Understanding (NLU) processing on the text to obtain an intention to be executed. The speech recognition module may be provided in an independent server, or in a development end, a service generation end, a service deployment end, and the like. After the intention to be executed is recognized from the user speech to be executed, a feature service for the intention is searched for, and the intention is sent to the service deployment end where the feature service is deployed. The service deployment end executes the feature service codes for the intention. In an execution process of the codes, resources may be returned to the device end accordingly. For example, a sound box picks up a speech ‘I want to play Game A’ from the user, sends the speech to the service generation end, performs a speech recognition to the speech, and determines that the intention to be executed is to start Game A. The intention to be executed is sent to the server where Game A is deployed. In the server, codes of Game A are retrieved according to the intention to be executed. The codes of Game A are executed and a main interface of Game A is returned to the sound box. The main interface may comprise an image, a text, a sound effect, a video, etc. Next, according to a user operation on Game A (e.g., a speech, a gesture or a mouse operation), a current intention of the user is recognized, the codes for the current intention are executed, and the resources in Game A are returned according to the recognized current intention step by step.

FIG. 4 illustrates a structural block diagram of a file generation device is provided according to an embodiment of the present disclosure. As illustrated in FIG. 4, the file generation device may comprise:

a receiving module 51 configured to receive attribute information of a feature;

an editing module 52 configured to edit a business logic of the feature; and

a generating module 53 configured to generate a description file for the feature according to the attribute information and the business logic.

In one embodiment, the receiving module 51 is further configured to receive the attribute information from a development end, wherein the attribute information comprises at least one of a type, basic information, and activation intention of the feature; wherein the basic information of the feature comprises at least one of a name, an icon, ownership information, and a presentation image of the feature.

In one embodiment, as illustrated in FIG. 5, the editing module 52 comprises:

a first determining sub-module 521 configured to determine a plurality of components in a description file structure, according to scenes in the business logic of the feature;

a second determining sub-module 522 configured to determine a relationship of the plurality of components according to a relationship of the plurality of scenes; and

an editing sub-module 523 configured to edit, on an edition interface, an attribute of the each component and the relationship of the plurality of components.

In one embodiment, each component in the description file structure comprises one or more of a session component, a node component, a card component, a show component, a template component, a hint component, a speech component, a condition-related state component, and a user-related state component.

In one embodiment, a type of the node component comprises one or more of a welcome node, an end node, a quit node, an interaction node, and an automatic jump node.

In one embodiment, the generating module 53 is further configured to generate a description file in a JSON format or an XML format according to the attribute information, components in the business logic, a relationship of the components, and an attribute of each component.

### Application Example 1

For example, in game development, the service generation system may be a game development and integration system of a dialogical Artificial Intelligent (AI) system. The game development and integration system of the dialogical AI system may be a role-playing oriented adventure game/story integrated development environment/platform. In this case, a non-programmed development of a speech feature game/story can be achieved, and the user can carry out development operations of a speech skill without programming.

A developer may select a template or customize a business logic through the system, and generate a plot description file by the visualized edition. Corresponding feature service codes and complete a deployment may be generated by the system according to the plot description file. The developer may conduct an on-line simulation and a real-world test to verify a specific application. Through the visualized edition of the plot, the online service will be updated by a service update technology. A personalized synthesis of the Text To Speech (TTS) can enhance the inspiration of the service and make the application be more personalized. In addition, for a game with an existing scripted description, an existing game script may be converted into a file in accordance with the plot description file structure of this solution, so that the codes are generated and the deployment is finished to realize a dialogical speech service.

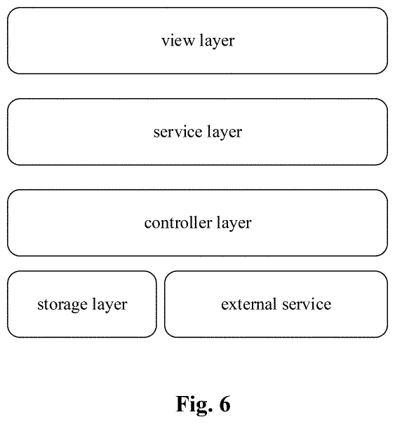

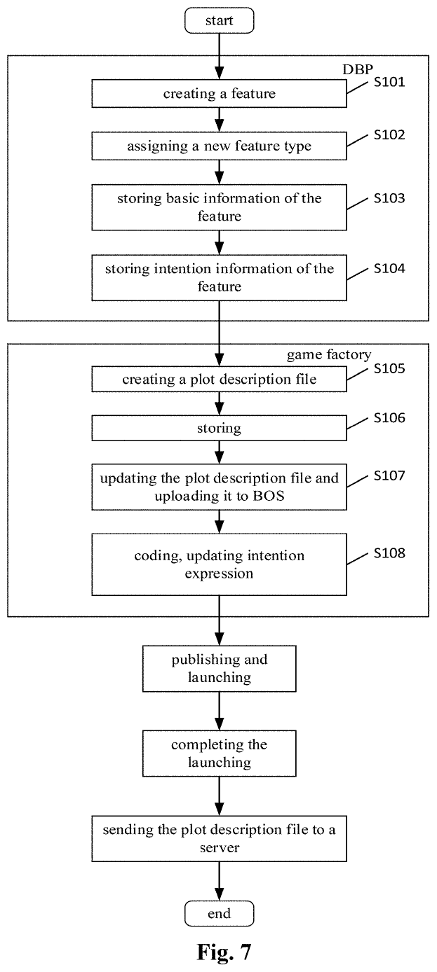

As illustrated in FIG. 6, the architecture of the system is as follows.

A view layer: A function of the visualized editor is realized, and an output result is a plot description file. In the view layer, it is possible to only edit the plot description file without storing the same. For example, the plot description file is stored to BOS. The view layer may receive attribute information of a feature from the development end. In the view layer, the visualized editor may be used to realize functions such as the front-end user design, editing the text, the graphic of the business logic, and the like.

A service layer: In the service layer, a request is sent to and returned from the view layer to a controller layer, and the output result of the visualized editor is sent to the controller layer, thereby playing a role of transferring. The generated plot description file may be stored to a storage layer through the service layer.

A controller layer: In the controller layer, the codes are generated according to the plot description file and the service is deployed. The controller layer may comprise a service generation end.

A storage layer: for example a Data Access Object (DAO) layer: it may serve as a platform database for storing the plot description file of the feature.

An external service: it may include, for example, a BOS, a TTS generation service, an audio database, an image library, etc. The content stored in the BOS may be directly pushed to the Content Delivery Network (CDN). In the audio database and the image library, reorganized audios, images, and the like of the plot description file may be stored. The TTS generation service may be used to convert a text in the plot description file that needs to be converted into a speech.

In addition, the system may also interact with the device end through an open platform. For example, an interaction may be made with the device end through a BOT engine integrated in a development platform such as the DBP.

Herein, the controller layer mainly provides the following functions:

1) Code generation. The plot description file is read to obtain the structure, the content, the configuration, etc., of the plot description file. The codes of PHP codes or codes in other programming language are generated in the controller layer.

2) Resources conversion. The resources in the plot description file are reorganized and placed in a designated location, a Data Access Object (DAO) layer, a CDN, etc. In the coding process, the resources such as images, audios, etc., in the plot description file are re-split and reorganized through the controller layer. For example, an image in the resources is transferred to a new storage device, a text outputted as a speech in the resources is converted into a text by means of the TTS, a Speech Synthesis Markup Language (SSML) splicing is performed, and so on. Next, the reorganized resources are stored into designated locations, such as different DAO layers, the external service, and the like. The generated codes may comprise the storage locations of the reorganized resources.

In the coding process, the intention and the dictionary may also be registered. For example, the activation intention of the feature and the intention for each scene are extracted from the plot description file. These intentions are registered to an open platform of a dialogical artificial intelligent system, such as the DBP. Each intention may comprise one or more words, which are saved into a dictionary system of the open platform. In this way, in the open platform, it is possible to recognize the received user speech to obtain an intention, and determine a feature for the intention. In addition, related marketing terms of different expressions representing the same intention may be saved into the dictionary system. After the service is deployed, if the user speech is received by the open platform, it is possible to determine the feature for the intention in the speech according to the intention, and send the intention to the server where the feature is deployed for processing.

3) Service deployment. The controller layer stores the generated execution codes, alone or together with the description file, into the designated server. When the codes of the service are to be executed, the resources may be read from the description file for the codes or from the storage location in the database indicated by the codes.

As illustrated in FIG. 7, a specific flow of the service development is as follows.

In S101, a feature is created in an open platform of a dialogical artificial intelligent system.

In S102 a new feature type is assigned.

In S103, basic information of the feature is stored.

In S104: intention information of the feature is stored.

In the open platform of the dialogical artificial intelligent system, such as a DuerOS Bot Platform (DBP), the function of the visualized editor can be used. The DuerOS is a dialogical artificial intelligent operation system, and the DBP is an open platform of the DuerOS. The BOT may be a chat robot dialogical system.

The feature may comprise an Internet application based on the Web Service, such as a game service, a story service, etc. The feature may also be referred to as an application service.

The type of the feature may comprise a game, a story, and the like.

The basic information of the feature may comprise: a name such as ‘Game A’, an icon, an author, whether to charge, a manufacturer, marketing term, ownership information, a presentation image, and the like.

The intension information of the feature may comprise an activation intension of the feature, which can express how to activate the feature, such as ‘start Game A’, ‘I want to play Game A’, and the like.

The present service can be distinguished from other services according to the attribute information such as the type, the basic information and the activation intention of the feature.

In S105, a plot description file is created in a game factory. The plot description file is also referred to as a script for short. For example, the game factory may generate a plot description file having a certain structure after receiving the attribute information, such as the type, the basic information and the activation intention of the feature from the open platform. The plot description file comprises the attribute information and the business logic of the feature. The business logic of the feature may comprise various scenes of the feature. For example, the business logic of a game feature comprises the content to be presented by the game feature in each scene. For another example, the business logic of the story feature comprises the story content of each scene of the story feature.

S106: storing the generated plot description file to a designated location such as a BOS system.

S107: in a case that the plot description file is updated, uploading the updated file to an object storage system such as a BOS system, and generating and storing a storage address in the BOS such as a Uniform Resource Locator (URL) for the plot description file.

S108: during coding, converting the plot description file into feature service codes by a code generator. The plot description file may be converted into the codes in multiple different programming languages, such as the PHP or other programming languages. During coding, the resources in the plot description file are reorganized and stored to the designated location.

During the coding, the intention expression may be updated. The updating of the intention expression can be understood as a generalization process. For example, an intention ‘entering the door’ may be generalized as ‘entering into’ and ‘walking into the door’. By updating an intention into a variety of commonly used expressions, the same intention can be expressed through the variety of expressions.

The generated plot description file is unchanged, and the intention expression is updated when the plot description file is coded and the service is deployed. In this way, when serving online, one intention may correspond to multiple expressions. For example, during visualized edition, if the activation intention of the feature only comprises entering the door, while during coding, the intention ‘entering the door’ may be expressed differently, such as ‘entering into’, ‘walking in’, etc.

Next, the service is deployed: the codes are stored to a designated server, and may be published and launched after being approved. After being launched, the plot description file may also be pushed to the server where the codes are deployed.

### Application Example 2

The plot description file is similar to a Directed Acyclic Graph (DAG), which branches into a binary tree or any other tree structure from the root node and proceeds step by step along different branches according to the conditions. A series of symbols are used to represent the flow of each scene of the business logic. Each scene may comprise a plurality of links or steps. Each node may be described in different ways. For example, the root node may comprise an activation intention of a feature. The node closely subordinate to the root node may comprise a next scene after the feature is entered.

For example, the graph branches into a binary tree or any other tree structure from the root node and proceeds step by step along different branches according to the conditions. A series of symbols are used to present the flow of each scene of the business logic. Each scene may comprise a plurality of links or steps. Each node may be described in different ways. For example, the root node may comprise an activation intention of a feature.

The specific business logic of the game is implemented in the plot description file that further comprises external attribute information of the game: entry information, a name, an author property right, a manufacturer, marketing terms, ownership information, a shown image, etc.

The plot description file may be described in the format of an eXtensible Markup Language (XML) or a JavaScript Object Notification (JSON), wherein the file may comprise a plain text description, and the shown part of the description file is generated by a visualized edition. The description file may be used to generate the codes at one click.

The plot description file structure may comprise components such as a session, a node, a card, a show, a template, a hint, a speech, a condition-related state, a user-related state, etc., wherein the card, the show and the template are presentation forms, the show may indicate a presentation form related to the DuerOS Presentation Language (DPL) and any other extension form. The hint indicates a guidance hint, and the speech indicates a voice. The user-related state indicates a state currently related to the user in the plot, such as the physical power. The condition-related state is related to an environmental change, a condition, a calculation, etc., such as windy, lack of goods, etc.

The attributes corresponding to each component may be preset, such as a description of the JSON format. For example, the attributes of the session component may comprise: a game name, a game type, comprised nodes, a background image, a session identification, a welcome node, etc. For another example, the attributes of the node component may include: a node identification, a node name, a node type, and a scene corresponding to the node. The attributes of the show component may include: a template and a DPL description. The specific contents of these attributes may be set in the interface of the visualized editor.

The node is an important component in the plot description file structure. The node type may comprise: a welcome node, an end node, a quit node, an interaction node (node class of various dialogs) and an automatic jump node. In which, the welcome node may be corresponding to a root node such as a feature entry. The quit node may be corresponding to a quit while the game is partially played. The interaction node may be corresponding to the scenes of various dialogs. The automatic jump node may be corresponding to a transitional scene. For example, after ‘I'm going to Chang'an’ is clicked, the screen scrolls and displays the introduction about Chang'an: ‘Chang'an is . . . ’. For another example, after the game is passed through, the flow automatically jumps to a scene such as ‘welcome’ and then jumps to a next interaction node. Through the automatic jump node, the user may jump to a node corresponding to the next scene automatically without making an interaction.

The plot description file may comprise a plurality of sessions, each of which may comprise a plurality of nodes, and each of the nodes may be corresponding to a scene. The attribute content of a node may be set according to the need of the scene. For example, it is possible to add a node and set the attributes thereof, indicating what someone says, whether there is an interaction, another scene (corresponding node) entered, etc. After all the scenes (corresponding nodes) and their execution sequence comprised in the game are set, Generate is clicked to generate a plot description file of the game, and then the description file is parsed to generate the codes.

In the plot description file, the show class scenes may be described with the DPL. For example, the game scene comprises: the user says ‘enter the hotel’, while after the entry, the bartender says ‘what do you want to eat’ and the user says ‘I want to eat beef. In the background service, the bartender says ‘the beef is AA (money)’ and shows a beef image described with the DPL as ‘a dish of beef’; the bartender says ‘do you want to eat this dish of beef?’. Then, the flow returns to the system. In this case, the dialog and the beef image to be displayed in the description file may be described with the DPL.

In the visualized editor, the information of the device may also be set so that the service can be adapted to different presentation devices. For example, when the user's speech from the device end reaches the feature service through the dialogical AI system, in addition to returning an effective speech broadcast, the feature service may generate corresponding DPL description according to the screen type of the device end, and return the DPL description to the dialogical AI system. The open platform of the dialogical AI system converts the DPL description into specific information and displays the information on the screen of the device end. In which, the screen type may comprise: with a screen, without a screen, a screen size, etc. An example of generating the DPL descriptions according to the screen type comprises: assuming that one image and one audio need to be shown at the device end; the DPL descriptions of the image and the audio are stored at the root node; only the audio is returned for a sound box without a screen, and the audio and the image can be both returned for a sound box with a screen.

In one example, assuming that the name of the game is ‘Game xx’, and the business logic of the game comprises a plurality of scenes.

Scene 1: after the game is entered, ‘welcome to Game xx, please say start the game’ will be presented; after the game is entered again, ‘welcome to the game simulation again, please say continue the game’ will be presented. The presented content may take multiple component presentation forms, such as a card, a show, a speech and the like. The welcome node may be used in the scene.

Scene 2: after a certain restaurant in the game is entered, ‘you come to the restaurant, and what do you want to eat’ will be presented; after the restaurant is entered again, ‘you come to the restaurant again, and what do you want to eat’ will be presented. The presented content may take multiple component presentation forms, such as a card, a show, a speech and the like. The interaction node may be used in the scene.

Scene 3: when it needs to quit the game, ‘are you sure to quit the game?’ will be presented, and the game is quit after a confirmation by the user. The presented content may take multiple component presentation forms, such as a card, a show, a speech and the like. The quit node may be used in the scene.

According to the above scenes, the node corresponding to each scene is determined, the contents of the attributes in the node are set, and a description file including logical description pseudo codes in the JSON format, for example, is generated. The description file may include the name, the node, the scenes and the like of the game.

The service generation system according to an embodiment of the present disclosure is suitable for an interaction scene of an intelligent speech device with a screen, and it is possible to obtain good visualized interaction experiences on the display device with limited computing and storage resources. The service generation system in the embodiments of the present disclosure is also suitable for an interaction scene of a device without a screen.

The plot description file in the embodiments of the present disclosure may be generated using a visualized editor.

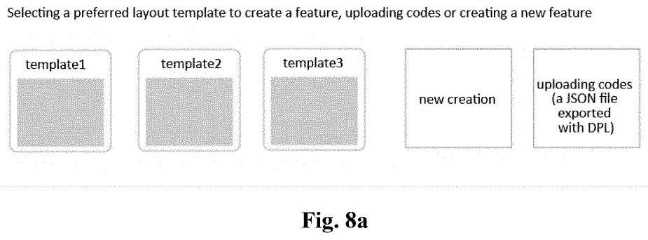

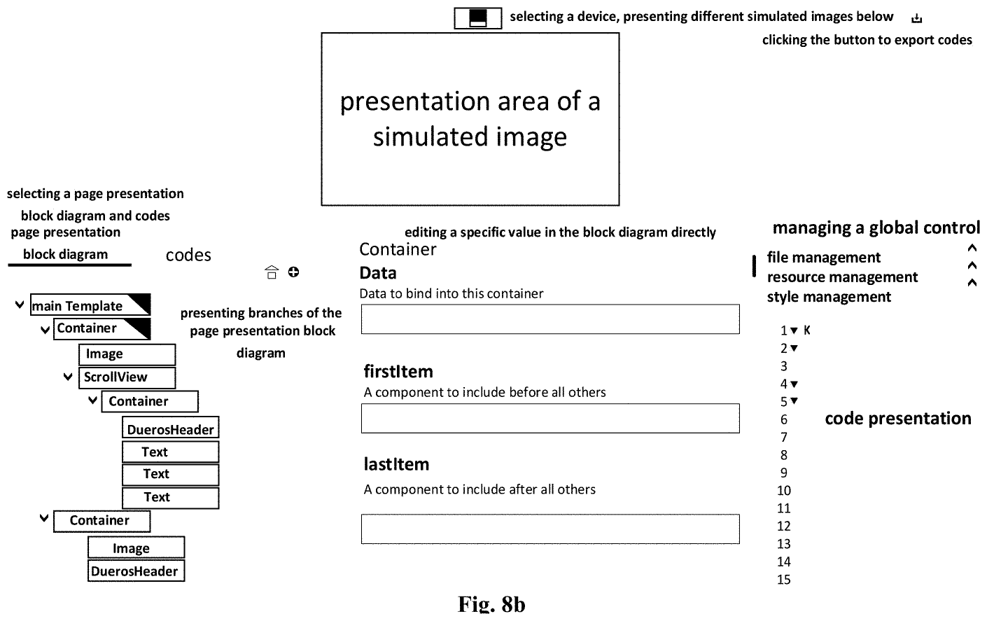

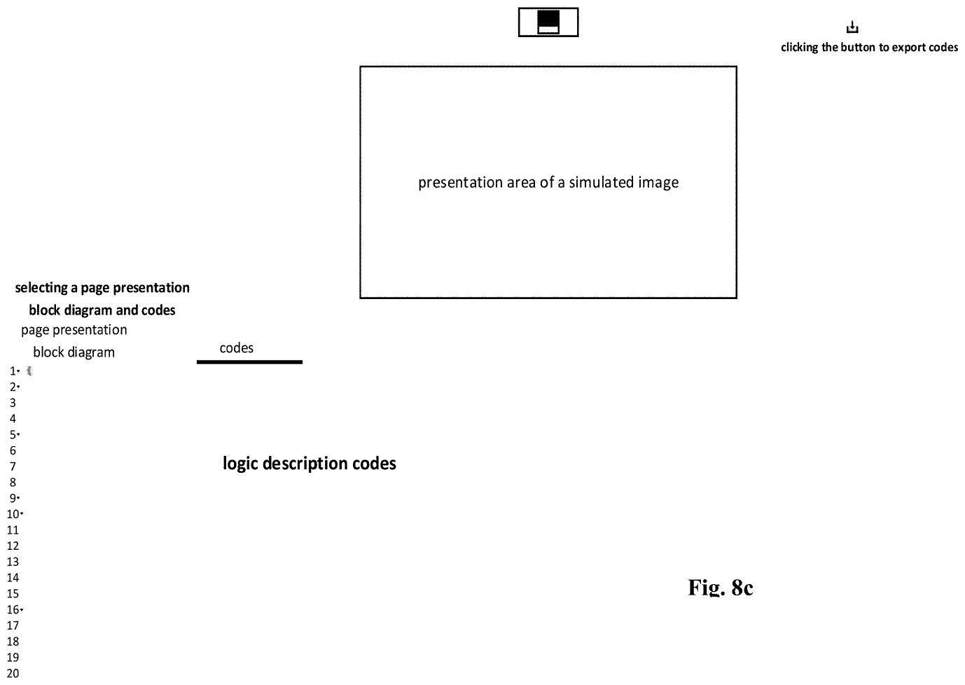

As illustrated in FIGS. 8a, 8b and 8c, the interface of the visualized editor may be classified into a template selection interface and a code edition interface.

As illustrated in FIG. 8a, the user may perform the following operations in the template selection interface:

1) creating a new presentation, e.g., in response to a selection operation on a newly created option ‘new creation’, jumping to a page where a new presentation form is to be created;

2) uploading a code file or a resource file, etc., e.g., in response to a selection operation on a file upload option ‘uploading codes’, jumping to a page where a code file or a resource file is to be uploaded;

3) selecting a default presentation form or template of the system, e.g., in response to a selection operation on a certain template, loading the selected template.

In the template selection interface, the user may select a preferred layout template to create a feature by uploading a code file or creating the skill. The layout template includes many types, such as a simple picture, a long text, a short text, and a combination of graphics and text.

As illustrated in FIG. 8b, the following operations may be performed in the code edition interface:

1) directly presenting the presentable fields through a page presentation block diagram.

For example, a left part illustrates clear framework structures and hierarchies; a right part directly prompts the user of the modifiable fields that can be edited in a text box.

2) after selecting global attributes, displaying a code framework having a global influence. For example, the file, the style, the resources, or the modification by the user will change the global presentation state.

3) selecting different devices. For example, if the user clicks a device selection control at the top, different simulator effects will be presented below (the screen types of various devices may be different from each other).

4) exporting the codes. In the upper right corner is a code export control, which may be clicked by the user to export the codes of the file.

As illustrated in FIG. 8c, it is a schematic diagram after switching to a code edition. After the switching to the code edition, the entire bottom may be an operation range for the code edition. The codes may be modified within this operation range.

The visualized editor has the following advantages:

1. A complex front-end edition interface is presented through a flow block diagram, with a clear hierarchical structure, and can be directly edited by clicking, which is convenient for the operation.

2. Different devices can be selected so as to simulate the presentation results for different devices. Moreover, each time the edition is performed, simulated display results for different devices are displayed in real time.

3. The presentations of the framework diagram and the code selection are supported, which greatly improves the development efficiency.

4. The code export is supported, with a variety of built-in templates.

5. The modules of a core logical part are separated for a selection and codes of each of the modules directly edited.

### Application Example 3

The plot description file may be automatically converted into the PHP codes. For example, corresponding PHP codes may be generated according to the components in the plot description file structure, the logical relationships between the components, etc. In the code generation process, the resources may be converted. For example, if an image is given in the description file, the image may be saved into the CDN. If a text is given in the plot description file, the text is converted into sound. In addition, registrations of an intention and a dictionary may be carried out. An intention is extracted from the plot description file to complete the intention registration, and common marketing terms similar to the intention are used to perform the dictionary registration.

Next, the generated feature service codes are deployed to a designated server. For example, a feature service is deployed to a storage space generated by an open platform, such as a DBP, of a dialogical artificial intelligent system. When the feature service is performed, the marketing term text resources may be returned to the open platform, and eventually returned to the device end (e.g., a smart sound box) by the open platform. The servers to which the feature service is deployed may be determined by a certain algorithm. For example, how to deploy a service is determined according to the number of the servers in the cloud, the load conditions, the space conditions, the newly requested servers, the reuse of one or more servers, etc. After being deployed, the service is audited and may be brought online after passing the audit.

In addition, in the visualized editor, the intention or the dictionary may be edited by clicking. The speech will be converted into an event, similar to an event generated by a mouse click, i.e., the intention registered by the feature service. The open platform of the dialogical artificial intelligent system recognizes the intention from the user's speech through the ASR and NLU. The recognized intention is sent to the server where the generated codes are located. After receiving the intention, the server executes the codes corresponding to the intention.

For example, when the user utters a speech ‘start Game A’ to the sound box, the sound box sends the speech to the open platform to convert it into an intention. The open platform may find a feature service ‘Game A’ to which the intention belongs according to the intention registration information, thereby sending the intention to a server where the feature service ‘Game A’ is deployed. After receiving the intention, the server executes the feature service code corresponding to the intention. The execution result is returned to the open platform. If there is a DPL description, the open platform may perform a visualized show through the DPL. The open platform sends this service resource, such as a sound, an image, etc., to the intelligent sound box or other device end.

The example is described through the conversion of the plot description file into the PHP codes, and any other programming language is implemented similarly. The PHP codes may comprise a plurality of files of the PHP format, such as the files ending with Php′. These files comprise the specific PHP code content.

For example, the directory structure of the PHP codes may comprise a controller file, such as an entry, an event processing class, an intention event processing root class, an intention processing class, a node parsing class, and a BOT class. The directory structure of the PHP codes may also comprise a configuration file, a Continuous Integration (CI) file, a story file, a lib file, etc.

The intention processing class may comprise the PHP format files of various intentions. For example, startintention.class.php indicates a start intention and corresponds to the welcome node; restartintention.class.php indicates a restart intention; answerintention.class.php indicates an answer intention and corresponds to a user's answer; repeatintention.class.php indicates a repeat intention; and sessionendedrequest.class.php indicates an end intention and corresponds to the end node.

The node parsing class may comprise the PHP format files for a variety of nodes, such as basenode.class.php, endnode.class.php, quitnode.class.php, nodeparser.class.php, normalnode.class.php, questionnode.class.php, conditionnode.class.php, randomnode.class.php, childnode.class.php, welcomenode.class.php and startnode.class.php.

If a scene in the plot description file needs an audio, the plot description file may directly include a text (converted into a speech through the TTS service), and an URL or an audio file may also be given. The URL is usually a verified accessible web page address. For example, if it needs to play a song after the user asks ‘have you eaten yet’, the audio file or the URL of the song to be played may be comprised in the plot description file.

Corresponding executable codes may be automatically generated with the plot description file by the code generator, and deployed to an open platform, such as the DBP, of the dialog AI system. The registrations of the intention and the dictionary of the feature service, the resource conversion, and the like involved during the period may refer to relevant descriptions of the above embodiments.

### Application Example 4

The existing scripts, such as those of the plot class game, may be directly converted into the content conforming to the plot description file structure in the embodiments of the present disclosure by means of metadata mapping and file uploading, thereby generating the services that may be executed on the device end such as the intelligent speech device.

The process of migration and conversion may include:

1. Metadata mapping. An existing script may be referred to as a file to be migrated. The metadata in the existing script is associated with the metadata in the plot description file structure by means of mapping.

The metadata of the existing script may include data similar to the components in the plot description file structure in the embodiments of the present disclosure. For example, the metadata of the existing script may comprise attribute information such as a name, an author, a manufacturer and an icon of the game, which are associated with the name, the author, the manufacturer and the icon of the feature in the plot description file structure, respectively.

The metadata of the existing script may also include specific scenes. For example, a first scene in the metadata of the existing script is associated with the root node in the plot description file structure, and a second scene in the metadata of the existing script is associated with the child node of the root node in the plot description file structure.

For example, the contents of the scene, the plot, the link, etc. in the file to be migrated may correspond to the attribute information of the sessions or nodes in the plot description file structure. For another example, a question in the file to be migrated may be corresponding to the attribute information of the speech in the file to be migrated.

2. Uploading the existing script to the open platform, such as the DBP, on the development end. In the DBP, the script is parsed according to the above mapping relationship to generate a content conforming to the plot description file structure, i.e., a plot description file. Next, the plot description file is used to automatically generate the codes and deploy the service.

A mapping relationship is established between the scene in the existing script and the session component, the node component, etc., in the plot description file structure of the solution. Next, a file conforming to the plot description file structure, which is similar to the DAG, is generated from the existing script. In this way, the existing script can be fully reused, so as to quickly generate the plot description file, and rapidly realize the service on the device end such as the intelligent speech interaction device.

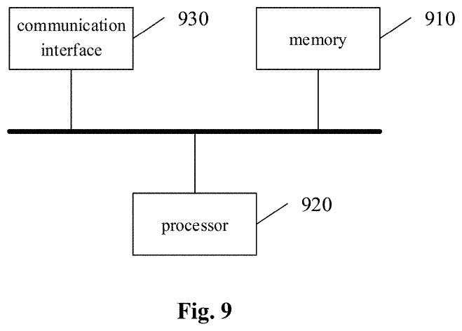

FIG. 9 illustrates a structural block diagram of a file generation apparatus according to an embodiment of the present disclosure. As illustrated in FIG. 9, the apparatus may include:

a memory 910 and a processor 920, wherein a computer program executable on the processor 920 is stored in the memory 910. When the processor 920 executes the computer program, the file generation method in the above embodiments is implemented. There may be one or more memories 910 and one or more processors 920.

The apparatus further comprises:

a communication interface 930 configured to be communicated with an external device for a data interactive transmission.

The memory 910 may comprise a high-speed random access memory (RAM), and may also comprise a non-volatile memory, such as at least one disk memory.

If being implemented independently, the memory 910, the processor 920 and the communication interface 930 may be connected to each other through a bus and perform communications with each other. The bus may be an Industry Standard Architecture (ISA) bus, a Peripheral Component (PCI) bus, an Extended Industry Standard Component (EISA) bus, or the like. The bus may be classified into an address bus, a data bus, a control bus, etc. For the convenience of reshow, a single thick line is used in FIG. 9, but it does not mean that there is a single bus or one type of bus.

Alternatively, during implementation, if being integrated onto one chip, the memory 910, the processor 920 and the communication interface 930 can perform communications with each other through internal interfaces.

A computer readable storage medium is provided according to the embodiments of the present disclosure provide storing a computer program, which implements the method according to any one of the above embodiments when being executed by a processor.

Among the descriptions herein, a description referring to the terms ‘one embodiment’, ‘some embodiments’, ‘example’, ‘specific example’, ‘some examples’, or the like means that specific features, structures, materials, or characteristics described in conjunction with the embodiment(s) or example(s) are included in at least one embodiment or example of the present disclosure. Moreover, the specific features, structures, materials, or characteristics described may be incorporated in any one or more embodiments or examples in a suitable manner. In addition, persons skilled in the art may incorporate and combine different embodiments or examples described herein and the features thereof without a contradiction therebetween.

In addition, the terms ‘first’ and ‘second’ are used for descriptive purposes only and cannot be understood as indicating or implying a relative importance or implicitly pointing out the number of the technical features indicated. Thus, the features defined with ‘first’ and ‘second’ may explicitly or implicitly include at least one of the features. In the description of the present disclosure, ‘a (the) plurality of’ means ‘two or more’, unless otherwise designated explicitly.

Any process or method description in the flow chart or otherwise described herein may be understood to mean a module, a segment, or a part including codes of executable instructions of one or more steps for implementing a specific logical function or process, and the scope of preferred embodiments of the present disclosure comprises additional implementations, wherein the functions may be performed without in a sequence illustrated or discussed, including being performed in a substantially simultaneous manner according to the functions involved or in a reverse sequence, which should be understood by skilled persons in the technical field to which the embodiments of the present disclosure belong.

At least one of the logics and the steps represented in the flow chart or otherwise described herein, for example, may be considered as a sequencing list of executable instructions for implementing logical functions, and may be embodied in any computer readable medium for being used by or in conjunction with an instruction execution system, an apparatus or a device (e.g., a computer-based system, a system including a processor, or any other system capable of fetching and executing instructions from the instruction execution system, the apparatus, or the device). Regarding this specification, the ‘computer readable medium’ may be any means that can contain, store, communicate, propagate, or transfer a program for being used by or in conjunction with the instruction execution system, the apparatus, or the device. More specific examples (non-exhaustive list) of the computer readable medium include an electrical connection portion (electronic device) having one or more wires, a portable computer enclosure (magnetic device), a random access memory (RAM), a read only memory (ROM), an erasable editable read only memory (EPROM or flash memory), an optical fiber device, and a portable read only memory (CDROM). In addition, the computer readable medium may even be paper or any other suitable medium on which the program is printed, because the program can be electronically obtained, for example, by optically scanning the paper or other medium, and editing, interpreting, or processing in other suitable ways if necessary, and then stored in a computer memory.

It should be understood that various parts of the present disclosure may be implemented by hardware, software, firmware, or combinations thereof. In the above embodiments, a plurality of steps or methods may be implemented by software or firmware stored in a memory and executed with a suitable instruction execution system. For example, if hardware is employed for implementation, like in another embodiment, the implementation may be made by any one or combinations of the following technologies known in the art: a discreet logical circuit having a logical gate circuit for implementing logical functions on data signals, an application specific integrated circuit having an appropriate combinational logical gate circuit, a programmable gate array (PGA), a field programmable gate array (FPGA), etc.

Persons of ordinary feature in the art can understand that all or part of the steps carried by the above method embodiments can be implemented by instructing relevant hardware through a program, wherein the program may be stored in a computer readable storage medium, and it includes one or combinations of the steps of the method embodiments when being executed.

In addition, the functional units in various embodiments of the present disclosure may be integrated into one processing module, or may be physically presented separately, or two or more units may be integrated into one module. The above integrated module may be implemented in the form of one of hardware and a software functional module. If the integrated module is implemented in the form of a software functional module and sold or used as an independent product, it may also be stored in a computer readable storage medium that may be a read only memory, a magnetic disk or an optical disk, etc.

Those described above are only embodiments of the present disclosure, but the protection scope of the present disclosure is not limited thereto. Within the technical scope revealed in the present disclosure, any skilled person familiar with the technical field can easily conceive of various changes or replacements thereof, which should be covered by the protection scope of the present disclosure. Therefore, the protection scope of the present disclosure should be subject to that of the accompanied claims.

1. A file generation method, comprising:
receiving attribute information of a feature;
editing a business logic of the feature; and
generating a description file for the feature according to the attribute information and the business logic.

2. The file generation method according to claim 1, wherein receiving attribute information of a feature comprises:
receiving the attribute information from a development end, wherein the attribute information comprises at least one of a type, basic information, and activation intention of the feature;
wherein the basic information of the feature comprises at least one of a name, an icon, ownership information, and a presentation image of the feature.

3. The file generation method according to claim 1, wherein editing a business logic of the feature comprises:
determining a plurality of components in a description file structure, according to scenes in the business logic of the feature;
determining a relationship of the plurality of components according to a relationship of the plurality of scenes; and
editing, on an edition interface, an attribute of the each component and the relationship of the plurality of components.

4. The file generation method according to claim 3, wherein the description file structure comprises one or more of a session component, a node component, a card component, a presentation component, a template component, a hint component, a speech component, a condition-related state component, and a user-related state component.

5. The file generation method according to claim 4, wherein a type of the node component comprises one or more of a welcome node, an end node, a quit node, an interaction node, and an automatic jump node.

6. The file generation method according to claim 1, wherein the generating a description file for the feature according to the attribute information and the business logic comprises:
generating a description file in a JSON format or an XML format according to the attribute information, components in the business logic, a relationship of the components, and an attribute of each component.

7. A file generation device, comprising:
one or more processors; and
a storage device configured for storing one or more programs, wherein
the one or more programs are executed by the one or more processors to enable the one or more processors to:
receive attribute information of a feature;
edit a business logic of the feature; and
generate a description file for the feature according to the attribute information and the business logic.

8. The file generation device according to claim 7, wherein the one or more programs are executed by the one or more processors to enable the one or more processors further to: receive the attribute information from a development end, wherein the attribute information comprises at least one of a type, basic information, and activation intention of the feature;
wherein the basic information of the feature comprises at least one of a name, an icon, ownership information, and a presentation image of the feature.

9. The file generation device according to claim 7, wherein the one or more programs are executed by the one or more processors to enable the one or more processors further to:
determine a plurality of components in a description file structure, according to scenes in the business logic of the feature;
determine a relationship of the plurality of components according to a relationship of the plurality of scenes; and
edit, on an edition interface, an attribute of the each component and the relationship of the plurality of components.

10. The file generation device according to claim 9, wherein the description file structure comprises one or more of a session component, a node component, a card component, a presentation component, a template component, a hint component, a speech component, a condition-related state component, and a user-related state component.

11. The file generation device according to claim 10, wherein a type of the node component comprises one or more of a welcome node, an end node, a quit node, an interaction node, and an automatic jump node.

12. The file generation device according to claim 7, wherein the one or more programs are executed by the one or more processors to enable the one or more processors further to: generate a description file in a JSON format or an XML format according to the attribute information, components in the business logic, a relationship of the components, and an attribute of each component.

13. A non-volatile computer readable storage medium storing a computer program, wherein the computer program implements the method according to claim 1 when being executed by a processor.
